(19) United States
(12) Patent Application Publication
(10) Pub. No.: US 2016/0292710 A1
(43) Pub. Date: Oct. 6, 2016

(54) MOBILE DEVICE INDUCEMENTS FOR CAUSING CONSUMER INTERACTIONS WITH KIOSKS, SUCH AS PRODUCT SAMPLE KIOSKS

(71) Applicant: Outerwall Inc., Bellevue, WA (US)

(72) Inventors: Omowale Casselle, Oak Park, IL (US); Ashtan D. Jordan, Chicago, IL (US); Franz Klein, Princeton, NJ (US)

(21) Appl. No.: 14/674,860

(22) Filed: Mar. 31, 2015

(51) Int. Cl. G06Q 30/02; G06Q 20/20; G07C 13/00; G06Q 20/18

(52) U.S. Cl. CPC G06Q 30/0237; G06Q 20/18; G06Q 20/202; G06Q 30/0211; G06Q 30/0209; G07C 13/00

(57) ABSTRACT

Consumer operated kiosks can be configured to provide product samples allowing consumers ‘try it before they buy it,’ which can help consumers make purchase decisions. Mobile device modules are disclosed herein that can generate inducements for consumers to interact with such consumer operated kiosks. Inducements can take the form of advertisements, notifications of product sample availability, messages indicating the mobile device is near a consumer operated kiosk, promotion codes, purchase receipts, product placement, etc. When and how the implementations provide inducements to consumers, and the type and content of the inducements, can be based on determinations of consumer product interest and kiosks that are relevant to the consumer. The implementations can discover product interest by observing consumer interaction levels with displayed products, receiving a vote for adding a product, purchasing a product sample, sending or receiving a message referring to a product, receiving advertising to include in an inducement, etc.

The present disclosure relates generally to systems, apparatuses and methods for providing product samples and, more particularly, to consumer operated kiosks for providing product samples and mobile device applications for generating an inducement for consumers to interact with such kiosks. U.S. Provisional Patent Application No. 61/556,717, U.S. patent application Ser. No. 13/671,299, and U.S. Design Patent Application 29/500,664 are each hereby incorporated herein by reference in their entirety.

### TECHNICAL FIELD

### Background

Every time consumers enter a retail establishment or make an online purchase, they are faced with numerous choices in product brand, type, size, color, shape, model, etc. One major retailer, for example, offers over 500 different types of perfume in over 80 different brands. The sheer volume of available products makes it difficult for consumers to make informed purchase decisions, which leads to the purchase of unwanted items, wasteful returns, and reluctance to try new products.

Numerous systems have been developed to help consumers make product purchase choices. Trademarks help consumers identify brands or products, permitting consumers to make purchase decisions based on their past experiences with particular products or brands. Online review systems help consumers share information about others' past experience with particular products, allowing consumers, to better anticipate their affinity for a product. These types of systems, however, often lead to consumers purchasing products they later decide they do not want, for example when the brand is inconsistent across product types, or when consumers do not share product affinities with a majority of reviewers.

Product manufacturers have often attempted to provide consumers with opportunities to personally experience specific products by providing product samples. The manufacturers, however, are faced with the problems and costs associated with finding effective distribution channels to provide the samples to users. Even when samples are distributed to consumers, such as through the mail or giveaways at events, many of the consumers who receive these samples will have no interest in the product, or they will not remember the product sample when they are subsequently in a position to make a purchase decision. Accordingly, it would be advantageous to provide product manufacturers, retailers, and others with efficient ways to provide consumers with product samples.

### BRIEF DESCRIPTION OF THE DRAWINGS

FIG. 1A is a schematic diagram illustrating entities which operate in some implementations of the disclosed consumer operated kiosk technology.

FIG. 1B is a block diagram illustrating an overview of mobile devices on which some implementations of the disclosed product sample application technology can operate.

FIG. 2 is a block diagram illustrating an overview of a network environment including a mobile device and a consumer operated kiosk in which some implementations of the disclosed technology can operate.

FIG. 3 is a block diagram illustrating components for inducting consumer interaction with a consumer operated kiosk.

FIG. 4 is a flow diagram illustrating a process used in some implementations for inducing, through a mobile device, consumer operated kiosk interactions.

FIGS. 5A-5F are flow diagrams illustrating various implementations of the process disclosed in FIG. 4 for inducing, through a mobile device, consumer operated kiosk interactions.

FIG. 6 is a flow diagram illustrating a process used in some implementations for generating a usage report related to usage of a product sample system.

FIG. 7 is process flow illustrating example interactions between various entities implementing the disclosed technology.

FIGS. 8A-8H are example screenshots of a user interface of an application executing on a mobile device implementing portions of the disclosed technology.

### DETAILED DESCRIPTION

Technology is disclosed herein for executing modules on a mobile device for interacting with consumer operated kiosks, such as consumer operated kiosks that provide product samples (“consumer operated kiosks”). Such modules can be associated with a sample application, or “sample app,” that is installed on the mobile device. In some implementations, events relevant to a consumer's interest in product samples (“interest events”) can occur on the mobile device, and the modules can obtain parameters relevant to detected interest events. A vend or dispense inducement (“inducement”) can then be generated based on the parameters relevant to the detected interest event. The inducement can be configured to persuade a consumer to interact with a consumer operated kiosk, such as by going to the consumer operated kiosk, purchasing one or more samples from the consumer operated kiosk, receiving one or more free samples at the consumer operated kiosk, setting up an account with a network for consumer operated kiosks, etc. As used herein, a “consumer” can be, for example, any user of a sample app or consumer operated kiosk.

Modules can be configured to monitor interest events or interest events can invoke one or more of the modules. Interest events can include, for example, a consumer selecting a particular product in a browser or other module of the sample app, a consumer completing an achievement in an entertainment module of the sample app, a location tracking module identifying that the consumer is in an area of interest, such as near a consumer operated kiosk, or a mobile device receiving a notification of a special offer from a third party such as a product sample provider or administrator of a consumer operated kiosk.

In some implementations, modules can obtain parameters relevant to detected interest events. In some implementations, the parameters include information about the detected event, such as a level of interaction with a module, features of a purchase transaction, features of a consumer associated with the event, communications received at the mobile device, usage or achievements of an entertainment module, playback of a specified media item, a time frame for the event or amount of time the event occurred, an acquisition of a new module, an in-app purchase, etc. In some implementations, the parameters include an indication of one or more product samples that may be of interest to a consumer, such as which product a consumer viewed or selected in a web browser or specialized mobile application, a level of interaction with an advertisement or other content item indicating a particular product, an indication of a product that the consumer voted to be added to a consumer operated kiosk, a product profit margin, a product with a special deal, past purchase histories of one or more products, product popularity, etc.

In some implementations, the parameters include information about one or more consumer operated kiosks, such as kiosk locations, kiosk inventories, the occurrence of a kiosk restock event, past interactions of a consumer with a kiosk, or a kiosk being selected by a consumer. In some implementations, the parameters include an indication of features to include in an inducement, such as an advertisement, special, promotion, or a media item pushed to a mobile device to be displayed to a consumer in an inducement. In some implementations, the parameters can include a combination of two or more of the foregoing types of parameters.

An inducement can be generated based on the parameters relevant to the detected interest event. An inducement can include any kind of message, display, or computing system output configured to promote consumer interaction with a consumer operated kiosk. For example, an inducement can include: a message that a product of interest is now available or has been restocked at one or more consumer operated kiosks, a message that there is a special on one or more product samples, an advertisement for one or more product samples, a message that the mobile device executing the modules is within a specified distance of a consumer operated kiosk or another location of interest, a map or directions to a specified consumer operated kiosk, a message that a consumer has been awarded an achievement or a free sample, or a message that a purchase of a product sample has been completed. In some implementations, inducements include a character code, QR code, or barcode that a consumer can enter or present to a consumer operated kiosk to receive discounted or free product samples. In some implementations, inducements provide an indication that a consumer's profile or payment method has been linked with a discount or a free product sample, which will be available upon their next visit to a kiosk.

Some consumers who receive inducements will be persuaded to interact with one or more consumer operated kiosks. In some cases, this will result in the consumer purchasing or otherwise receiving one or more product samples at a kiosk. The product samples can be coupled with a coupon or code for receiving a discount on a retail version of the product or on another product associated with the producer of the sample product. The consumer can present this coupon during a purchase transaction to receive a discount on the retail version of the product. In some implementations, the discount can be for as much or more than the purchase price of the sample. In some implementations, the code or coupon can be used after the purchase of a retail version of the product as a rebate or credit toward future purchases of related products or for other product samples.

As consumers interact with mobile device modules, consumer operated kiosks, and retail venders, the disclosed technology can capture data about these interactions. The disclosed technology can aggregate the captured activities or associates the captured activities with various parameters, such as location, consumer characteristics, timeframes, sample-to-retail-purchase conversions, product category, level of interaction with mobile device modules, retail chain or type, etc. The disclosed technology can generate reports using the aggregated data, and the reports can be provided to various entities, such as consumer operated kiosk operators, current or potential product manufacturers, retailers or retail chains, or consumers, etc.

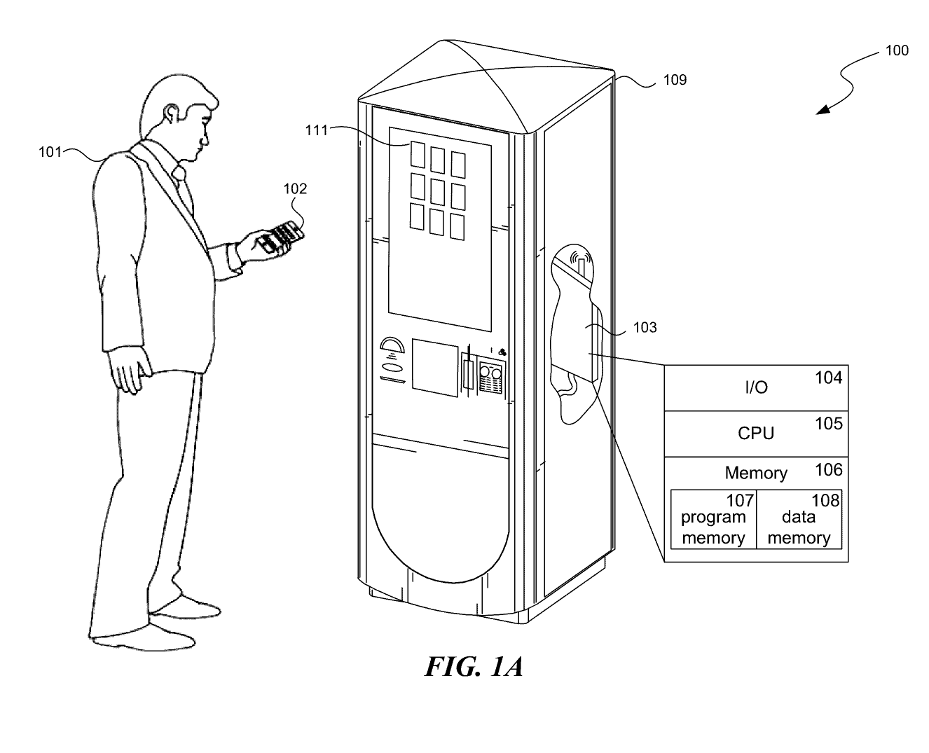

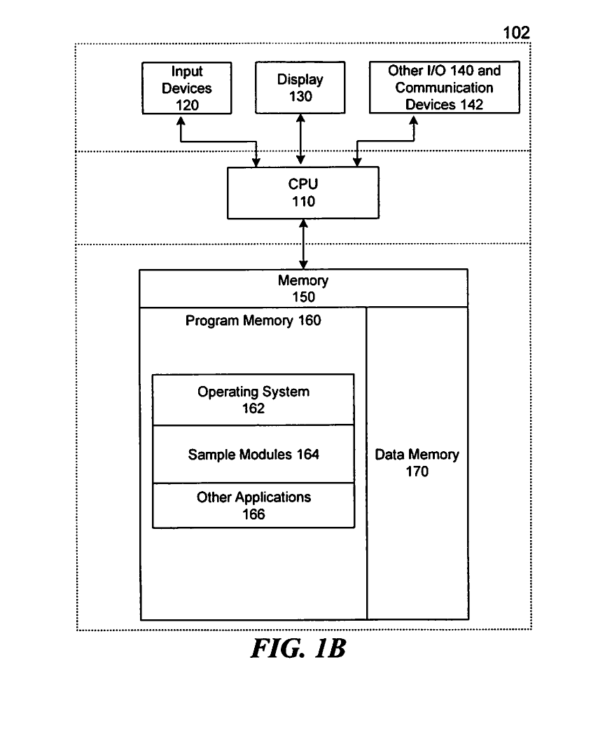

Certain details set forth in the following description and in FIGS. 1A-8H provide a thorough understanding of various embodiments of the present technology and disclosure. In other instances, well-known structures, materials, operations and/or systems often associated with product samples, advertising, wireless technology, mobile devices, smart phones, commerce platforms and functionalities, are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the disclosure. Indeed, certain terms may even be emphasized below; however, any terminology intended to be interpreted in any restricted manner will be overtly and specifically defined as such in this Detailed Description section.

The accompanying figures depict embodiments of the present technology and are not intended to limit the scope of this disclosure. Many of the details, dimensions and other features shown in the figures are merely illustrative of particular embodiments of the disclosure. Accordingly, other embodiments can have other details, dimensions and features without departing from the spirit or scope of the present invention. For example, the sizes of various depicted elements are not necessarily drawn to scale, and various elements may be arbitrarily enlarged and/or simplified to improve legibility. Component details may be abstracted in the figures to exclude details such as position of components and certain precise connections between such components when such details are unnecessary for a complete understanding of how to make and use the invention. Those of ordinary skill in the art will also appreciate that further embodiments of the invention can be practiced without several of the details described below.

In the figures, identical reference numbers identify identical, or at least generally similar, elements. To facilitate the discussion of any particular element, the most significant digit or digits of any reference number refers to the figure in which that element is first introduced. For example, element 102 is first introduced and described with reference to FIG. 1.

Several implementations of the disclosed technology are described below in more detail in reference to the figures. FIG. 1A is a schematic diagram illustrating entities 100 which operate in some implementations of the disclosed consumer operated kiosk technology. A consumer 101 can use a mobile device 102 (e.g., a smartphone) executing a product sample app. The product sample app can generate inducements for the consumer 101 to interact with one or more consumer operated kiosks, such as a product sample kiosk 109. The kiosk 109 can include computing components 103, such as I/O 104, a CPU 105, and memory 106, which can include program memory 107 and data memory 108. I/O, CPUs, and memory are described in more detail below in relation to FIG. 1B.

The consumer operated kiosk 109 can be a part of a consumer operated kiosk system run by administrators, connected to other consumer operated kiosks over a network through I/O 104, and stocked with multiple product and product sample types 111. In some implementations, the kiosk 109 can be at least generally similar in structure and formation to the kiosks described in detail in U.S. patent application Ser. No. 13/671,299 which is hereby incorporated by reference in its entirety. The mobile device 102 and the consumer operated kiosk 109 can communicate directly, such as using a WiFi, Bluetooth, or other wired or wireless connection, or through communication with an intermediary, such as a server or database in communication with both the mobile device 102 and the kiosk 109.

As an example, the consumer 101 can receive a promotion through a sample app running on the mobile device 102. The promotion can include, e.g., a promotion code and can indicate that the consumer 101 can receive a free sample at one or more of the consumer operated kiosks 109. The consumer can go to one of the kiosks 109 and enter the promotion code, authenticate to load a user profile indicating that the consumer 101 has received the promotion, or otherwise indicate using computing the components 103 that the consumer 101 has received the promotion. The consumer can also select one of the samples 111 at the consumer operated kiosk, which will be dispensed at no charge or at a discounted price, to be consumer 101 in response to the indication of the promotion. The sample can include a coupon for a discount on a retail version of the product. As used herein, a “retail version” refers to a typical packaged version of a product as found on, for example, shelves at the retailer. Consumer activities can be reported to one or more servers from the mobile device 102, the consumer operated kiosk 109, or as a result of retail purchases using sample coupons.

FIG. 1B is a block diagram illustrating an overview of a mobile device 102 on which some implementations of the disclosed product sample application technology can operate. The device 102 can comprise hardware components that execute a sample app and associated modules. The device 102 can include one or more input devices 120 that provide input to a CPU (processor) 110, notifying it of actions. The actions can be mediated by a hardware controller that interprets the signals received from the input device and communicates the information to the CPU 110 using a communication protocol. The input devices 120 can include, for example, a mouse, a keyboard, a touchscreen, an infrared sensor, a touchpad, a wearable input device, a camera or image-based input device, a microphone, or other user input devices.

A CPU can be a single processing unit or multiple processing units in a device or distributed across multiple devices. A CPU can be coupled to other hardware devices, for example, with the use of a bus, such as a PCI bus or SCSI bus. A CPU can communicate with a hardware controller for devices, such as for a display 130. The display 130 can be used to display text and graphics. In some examples, the display 130 provides graphical and textual visual feedback to a user. In some implementations, the display 130 includes the input device 120 as part of the display, such as when the input device 120 is a touchscreen or is equipped with an eye direction monitoring system. In some implementations, the display 130 is separate from the input device 120. Examples of display devices include: an LCD display screen, an LED display screen, a projected display (such as a heads-up display device or a head-mounted device), and so on. Other I/O devices 140 can also be coupled to the CPU 110, such as a network card, video card, audio card, USB, firewire or other external device, camera, printer, speakers, CD-ROM drive, DVD drive, disk drive, or Blu-Ray device.

In some implementations, the device 102 also includes communication devices 142 capable of communicating wirelessly or wire-based with a network node. The communication devices 142 can communicate with another device or a server through a network using, for example, TCP/IP protocols. The device 102 can utilize the communication devices 142 to distribute operations across multiple network devices.

The CPU 110 has access to a memory 150. A memory includes one or more of various hardware devices for volatile or non-volatile storage, and can include read-only or writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. The memory 150 includes program memory 160 that stores programs and software, such as an operating system 162, Samples App Modules 164, and any other application programs 166. The memory 150 also includes data memory 170 that can include location data; product data; sample availability; user profiles, favorite products, favorite kiosks, monitored activities, promotions earned, promotions used, purchase history, coupon usage history, and voting history; consumer kiosk usage reporting data; special promotions, and other notifications, configuration data, settings, and user options or preferences which can be provided to the program memory 160 or any element of the device 102.

The disclosed technology is operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, and the like.

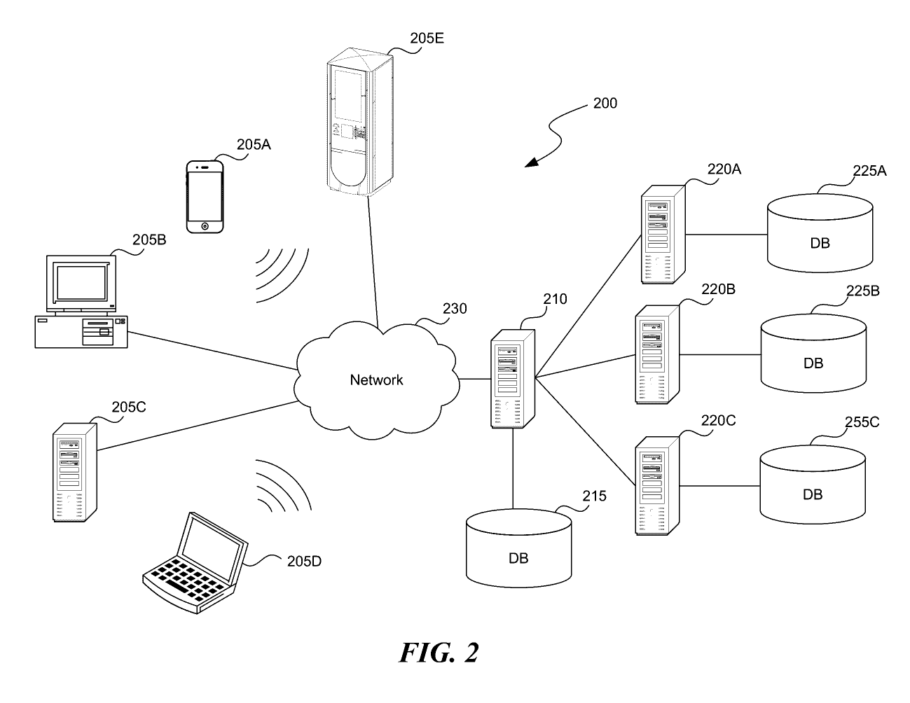

FIG. 2 is a block diagram illustrating an overview of a network environment 200 including a mobile device and a consumer operated kiosk in which some implementations of the disclosed technology can operate. The environment 200 can include one or more client computing devices 205A-E, examples of which may include one or mobile devices such as device 102 and one or more kiosks, such as kiosk 09. The client computing devices 205 can operate in a networked environment using logical connections via network 230 to one or more remote computers, such as a server computing device 210.

In some implementations, the server 210 can be an edge server which receives client requests and coordinates fulfillment of those requests through other servers, such as servers 220A-C. The server computing devices 210 and 220 can comprise computing systems, such as the device 102 or the product sample kiosk 109. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

The client computing devices 205 and the server computing devices 210 and 220 can each act as a server or client to other server/client devices. The server 210 can connect to a database 215. The servers 220A-C can each connect to a corresponding one of the databases 225A-C. As described above, each of the servers 220 may correspond to a group of servers, and these servers can share a database or can each have their own database. The databases 215 and 225 can warehouse (e.g. store) information such as kiosk locations and inventory; user profiles, favorite products, favorite kiosks, monitored activities, promotions earned, promotions used, purchase history, coupon usage history, and voting history; consumer kiosk usage reporting data; special promotions; etc. Though the databases 215 and 225 are displayed logically as single units, the databases 215 and 225 can each be a distributed computing environment encompassing multiple computing devices, can be located within their corresponding server, or can be located at the same or at geographically disparate physical locations.

The network 230 can be a local area network (LAN) or a wide area network (WAN), but can also be other wired or wireless networks. The network 230 may be the Internet or some other public or private network. The client computing devices 205 can be connected to the network 230 through a network interface, such as by wired or wireless communication. While the connections between the server 210 and the servers 220 are shown as separate connections, these connections can be any kind of local, wide area, wired, or wireless network, including the network 230 or a separate public or private network.

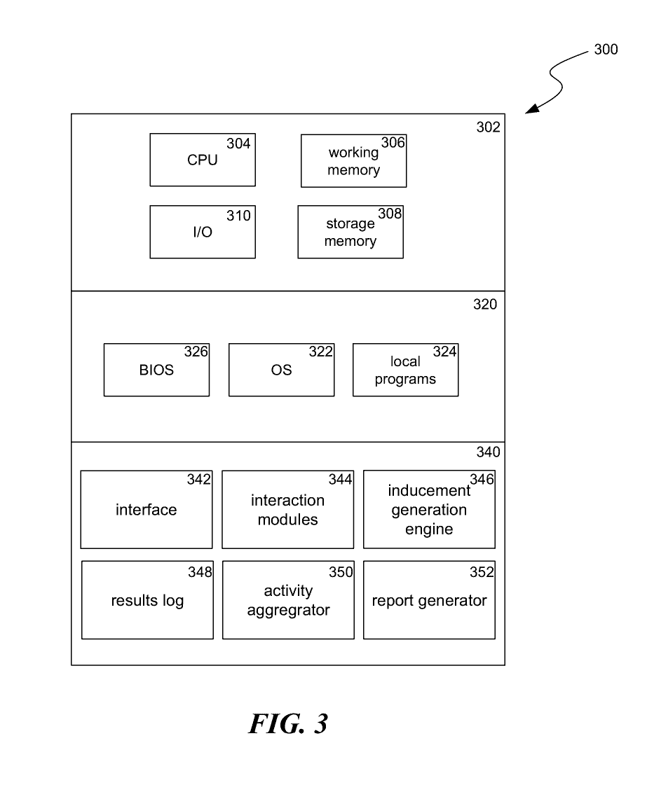

FIG. 3 is a block diagram computing components 300 for inducting consumer interaction with a consumer operated kiosk. The components 300 include hardware 302, general software 320, and specialized components 340. As described above, a system implementing the disclosed technology can use various hardware including central processing units 304, working memory 306, storage memory 308, and input and output devices 310. The components 300 can be implemented in a client computing device, such as the client computing devices 205 or on a server computing device, such as the server computing device 210 or 220.

The general software 320 can include various applications including an operating system 322, local programs 324, and a BIOS 326. The specialized components 340 can be subcomponents of a general software application of the local programs 324. The specialized components 340 can include interaction modules 344, an inducement generation engine 346, a results log 348, and activity aggregator 350, a report generator 352, and components which can be used for controlling, sending, and receiving data from the specialized components, such as interfaces 342.

The interaction modules 344 can be executed by a mobile device, such as the mobile device 102, as portions of a sample app with which consumers can interact, as processes to receive notifications from third parties, and as processes to observe consumer interaction with other features and apps of the mobile device. Portions of the sample app can include product category modules, product search modules, product list modules, product details modules, favorite product modules, favorite consumer operated kiosks modules, map modules, entertainment modules, voting modules, e-commerce modules, etc. Product category modules, product search modules, product list modules, and product details modules can allow a consumer to browse products via the sample app.

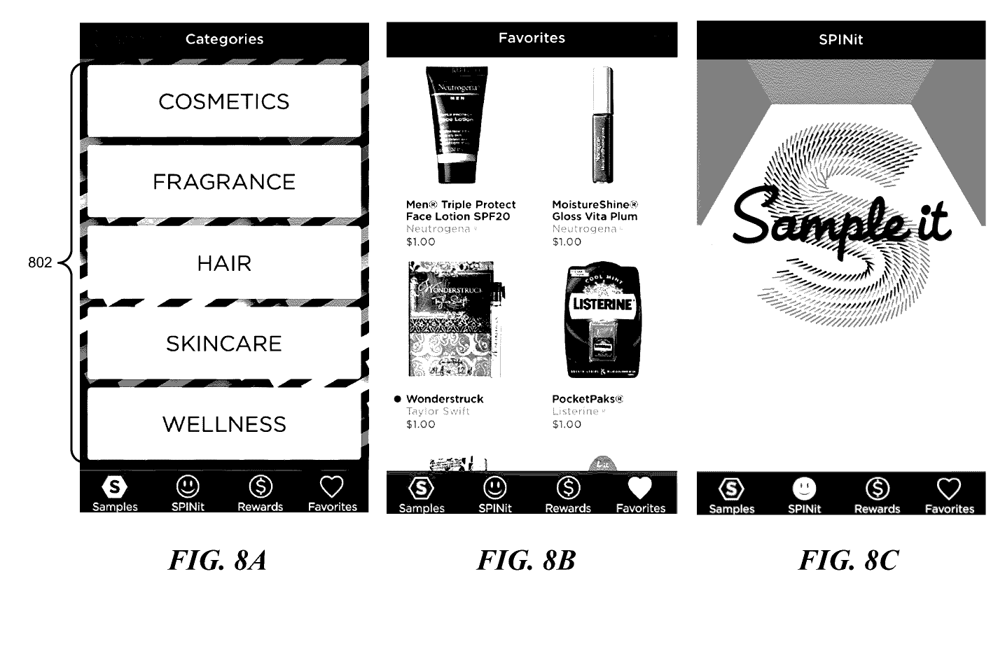

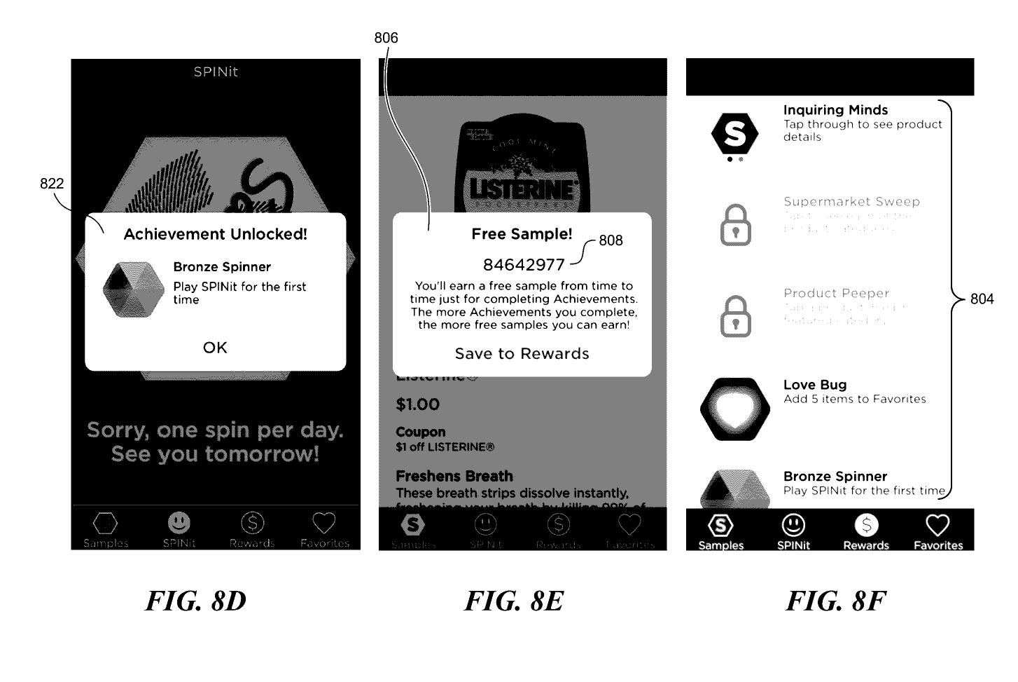

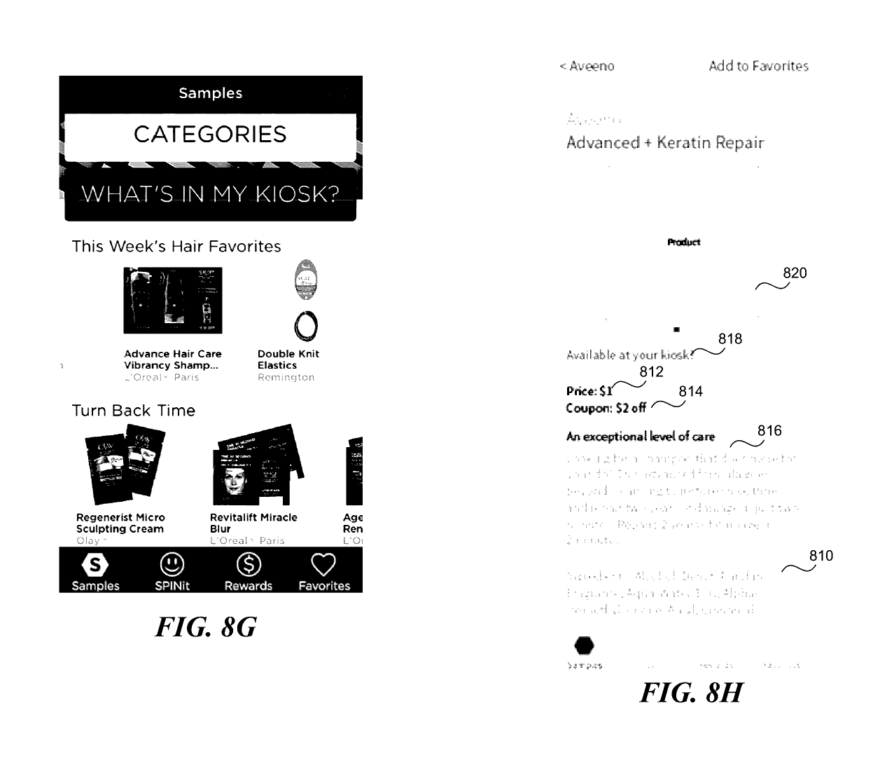

As an example of an implementation, a consumer can open the sample app and navigate to a product categories module where they select a “Cosmetics” category. An example of a user interface implementing a product categories interface is shown in FIG. 8A. Referring to FIG. 8A, the selection can take the consumer to a list module that displays a list 802 which lists the available products in the “Cosmetics” category. The list can be narrowed, such as by available products at a selected consumer operated kiosk or sorted, such as by price, by type, or based on a determined likelihood of consumer interest. The consumer can select a particular product sample from the displayed list 802, which can take them to a details module. An example of a user interface implementing a details module is shown in FIG. 8H. Selection of a particular product sample to activate a details module can also occur, for example, through a search performed in a search module, a selection of an available product sample in a favorite products module, or other ways. An example of a user interface implementing a favorite products module is shown in FIG. 8B. The details module can display additional information about the selected product sample, such as a description 816, ingredients 810, advertising information, availability 818, photos 820, reviews, price 812, coupon amount 814, etc.

Returning to FIG. 3, the interaction module 314 can determine the consumer's interest in the selected product sample based on the consumer's level of interaction with content associated with the product sample. The interaction module 314 can provide an indication of interest to an inducement generation engine 346, as described below. In an example, the consumer can then add the selected product sample to an e-commerce shopping cart and checkout through an e-commerce module. When the consumer subsequently visits a consumer operated kiosk, the consumer can then perform an authentication procedure and pick up the product sample.

Additional types of interaction modules, such as map modules, entertainment modules, and voting modules, can also be activated by a consumer. These modules can, for example, allow a consumer to get directions to a selected consumer operated kiosk, play a game or engage in other types of entertainment which can result in unlocking achievements or promotions, and can allow the consumer to vote for a product sample be added to the consumer operated kiosk system or to a particular consumer operated kiosk.

The interaction modules 344 can be executed by a mobile device as processes to receive notifications from third parties, such as a background process executing on the mobile device. The processes to receive notifications can be configured to receive updates, advertisements, special offers, etc. from other computing systems. For example, an administrator of a consumer operated kiosk system can make an agreement with a product sample supplier to promote the supplier's products. The administrator can produce an advertisement, such as a “buy one, get one free” advertisement and associated promotion code for the supplier's products. This advertisement/code can be transmitted to mobile devices executing an interaction module, or it can be accessed by an interaction module the next time the sample app is executed. This can cause the inducement generation engine 346 to provide an inducement including the advertisement or code as a notification or as a message upon the next sample app execution.

The interaction modules 344 can also be executed by a mobile device as observers of consumer actions with other features and apps of the mobile device. For example, the interaction module 344 can determine a consumer's interest in a particular product by observing the consumer searching for a topic related to the product, selecting an advertisement or other content item or related to the product, or making a purchase related to the product. These consumer actions can be observed in the sample app, in another specialized app provided by the same or a different provider, or through observed consumer actions in a general application, such as a web browser. In some implementations, devices other than the mobile device, such as a personal computer or other computing device associated with the consumer can operate the interaction modules 344. The interaction modules can then provide determined products of interest to the mobile device through a network connection for the inducement generation engine 346 to provide inducements for the consumer to visit a consumer operated kiosk.

The inducement generation engine 346 can produce inducements, such as alerts, advertisements, achievement and promotion indications, maps or directions, or other mobile device outputs configured to encourage a consumer to interact with a consumer operated kiosk and purchase or otherwise obtain product samples. The inducements can be based on information received from the interaction modules 344. For example, one of the interaction modules 344 can provide an indication of a consumer interest in one or more products. In response, the inducement generation engine 346 can generate an advertisement for the products of interest, provide a promotion for a discounted or free sample of the products of interest, identify one or more consumer operated kiosks that carry samples for the products of interest, etc.

As another example, one of the interaction modules 344 can provide an indication (i.e. an identifier, coordinates, a map, a memory pointer, etc.) of a particular one of the consumer operated kiosks 109. In response, the inducement generation engine 346 can generate an alert that the consumer is near the indicated consumer operated kiosk, a map or directions to the kiosk, a list of all products or products stocked at the kiosk that are determined to likely be of interest to the consumer, or specials at that particular kiosk.

As a further example, one of the interaction modules 344 can provide an indication of content received from a third party, such as an advertisement, a product to push, a current promotion, a location where a special deal is occurring, etc. In response, the inducement generation engine 346 can generate a message for the consumer, such as a notification or display within the sample app, incorporating some or all of the received content.

As yet another example, one of the interaction modules 344 can provide an indication that a consumer has performed a certain level of interaction within the sample app or an entertainment module. In response to the consumer performing the level of interactions, the inducement generation engine 346 can generate an inducement as an achievement. As used herein, an achievement can include one or more of: a notification to the consumer that the level of interaction has been completed; a promotion or special offer that the consumer receives as a result of completing the level of interaction; instructions for redeeming the promotion or special offer; or instructions on how to complete further achievements or further options within the entertainment modules, such as unlocking a level or granting an in-game item. The inducement generation engine 346 can provide the achievements, for example, as a pop-up or other indication in the application or entertainment module which prompted the achievement generation, as a mobile device notification, as a message displayed upon operation of the sample app, or as part of a list 804 of achievements in the sample app. An example of a user interface implementing a list of achievements 804 is shown in FIG. 8F.

A results log 348 can log consumer actions on the mobile device 102, at the consumer operated kiosk 109, or with a retailer. The results log 348 can receive indications of consumer actions on the mobile device from interaction modules 344 or inducement generation engine 346 and categorize them, determine relationships between them, and store them. In some implementations, results log 348 can receive actions by one or more consumers at consumer operated kiosks or retailers through interface 342. In some implementations, interface 342 can transmit results from results log 348 such as to a server 220 to be processed or stored in a database 225.

The activity aggregator 350 can receive reported activities from the activity log 348 and aggregate them into groupings, such as by activity type, time, related product, product type, product brand, interaction module associated with the activity, consumer operated kiosk involved with the activity, etc. The activity aggregator 350 can also abstract activity sets to develop conclusions. For example, the activity aggregator 350 can abstract, based on product types, activities identified as promotions that resulted in the consumer both purchasing a sample at a consumer operated kiosk and then purchasing the retail version of the product. A comparison between various product types can be made to determine, for example, if the percentage of this type of activity is much higher for a particular type of product, such as a, food product, as compared to other types of available products. This can result in a determination that the consumer associated with the mobile device will be receptive to advertisements for this type of product sample in the future. In some implementations, the activity aggregation can be performed by a computing system other than the mobile device. This facilitates aggregations across multiple consumers to help determine generalities for consumer groups, consumer demographics, kiosk locations, products, product types, timeframes, or other demographics relevant to product marketing, product sample production and stocking, administrating a consumer operated kiosk system, etc.

The report generator 352 can provide reports to various entities associated with the consumer operated kiosk system, such as a kiosk administrator, advertisers, product sample providers or potential providers, retailers hosting a consumer operated kiosk, etc. The report generator 352 can create reports on demand, on a schedule, or as relevant information becomes available. In various implementations, the report generator 352 can generate reports locally on a mobile device or at one or more remote systems with access to reported activities, activity aggregations, or abstractions.

Those skilled in the art will appreciate that the components described above with reference to FIGS. 1-3, and in each of the flow diagrams described below, may be altered in a variety of ways. For example, the order of the logic may be rearranged, substeps may be performed in parallel, illustrated logic may be omitted, other logic may be included, etc.

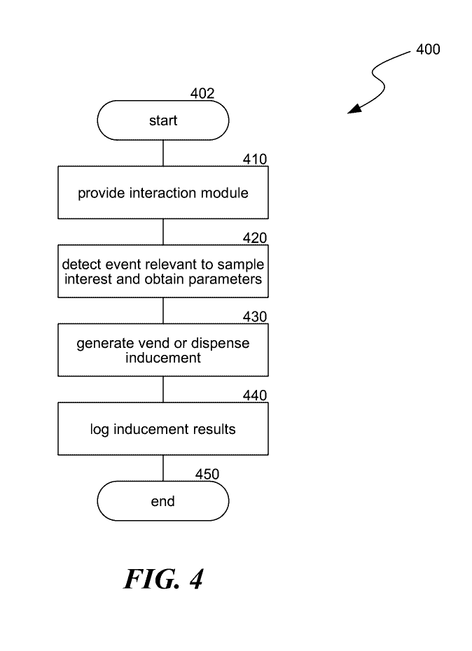

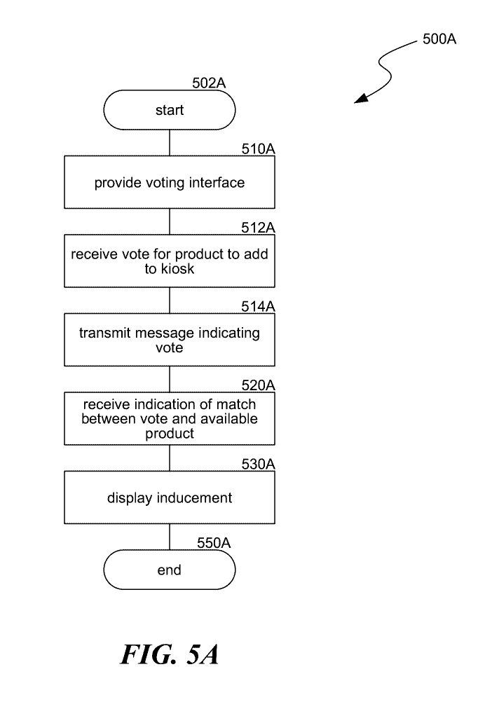

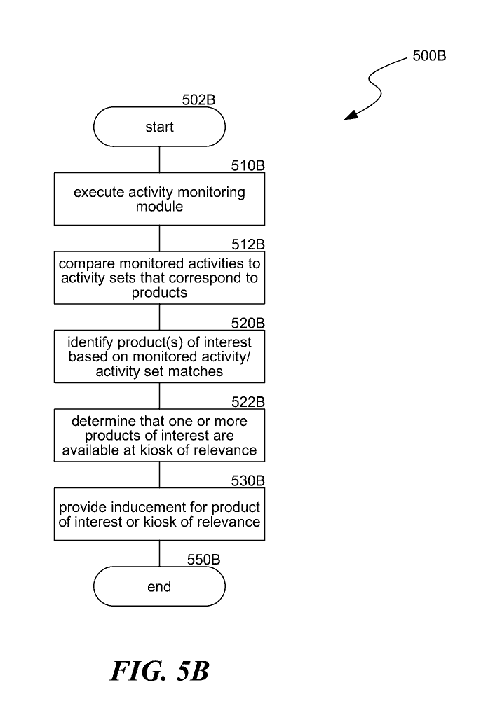

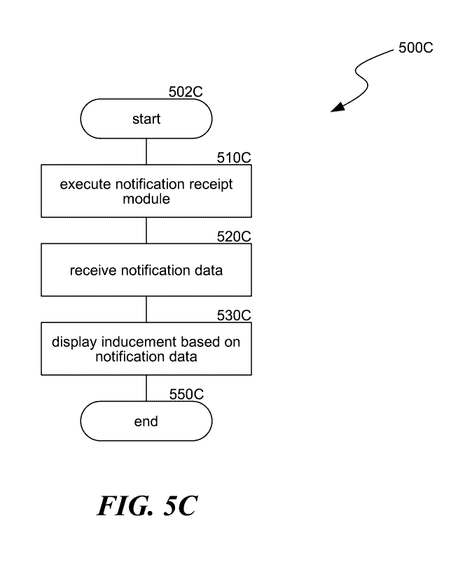

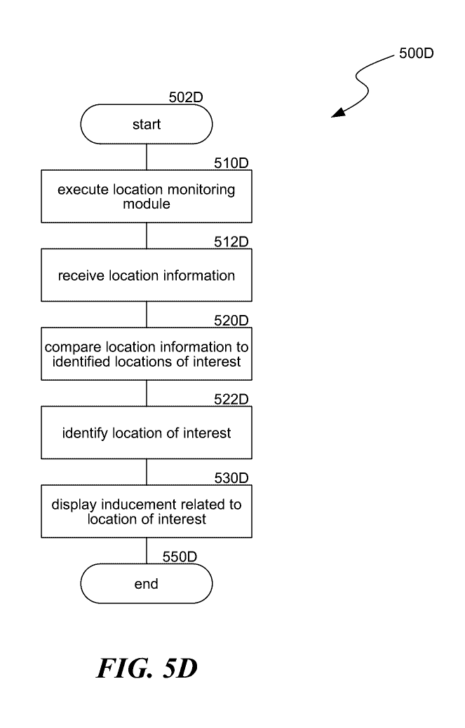

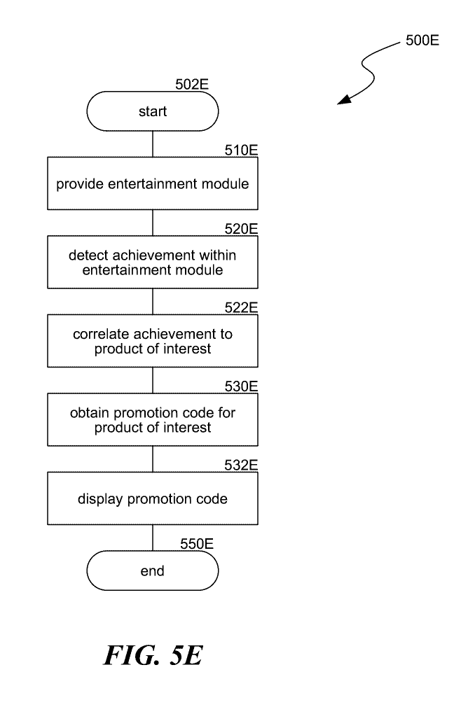

FIG. 4 is a flow diagram illustrating a process 400 used in some implementations for inducing with, for example, a mobile device, consumer interactions with a kiosk, such as the product sample kiosk 109 described above. Process 400 begins at block 402 and continues to block 410. At block 410, one or more interaction modules are provided. Process 400 can obtain interaction modules as part of a sample app. In some implementations, interaction modules can include interfaces and associated computing instructions to provide product sample information to consumers, to generate interest in product samples, and to promote the use of consumer operated kiosks as described above with reference to, for example, FIG. 3. In some implementations, the interactions modules can be modules that observe mobile device conditions and consumer interactions with other modules and applications. In some implementations, interactions modules can be modules that receive inducement content from third parties. Process 400 can execute, on a mobile device, interaction modules as part of a consumer running a sample app, they can be background processes run on the mobile device, or other events on the mobile device can trigger them, such as by the launch of another application. Implementations of providing interaction modules and types of interaction modules are discussed in more detail below in relation to blocks 510-518 of FIGS. 5A-5F.

At block 420, process 400 detects one or more events relevant to sample interest, and obtains parameters for the events. Events relevant to sample interest can be detected by the interaction module or modules provided at block 410. Events can be relevant to sample interest by virtue of their corresponding to one or more triggers. In some implementations, an event corresponds to a trigger by falling into a specific category of actions taken by a consumer. In some implementations, an event corresponds to a trigger when it indicates one or more mobile device characteristics, such as a location of the devices in a vicinity of a kiosk, or when it runs a process on the device, which has been identified for sample interest. In some implementations, an event corresponds to a trigger by being associated with information received from a third party indicating the information is for an inducement or other message to the consumer, such as a product advertisement or a kiosk system promotion.

At block 420, interaction modules can also obtain parameters of the detected events. In various implementations, the event parameters can be included with the event, can be obtained from other information stored on the mobile device, or can be obtained from a third party through a network connection. Parameters can be any information regarding the detected event that can be used in the generation of an inducement. In some implementations, parameters can include information about the context of the event, such as when it occurred; a location of the mobile device when the event occurred; an indication of one or more applications executing on the mobile device at the time of the event or that triggered the event; other information stored for this type of event; stored information corresponding to the consumer for the event; or a mapping of other to inducement content. In some implementations, parameters can include data received as part of the event, such as a web page or product a consumer is viewing, purchasing, or interacting with; portions of a message sent by the consumer; content received from a third party to include in an inducement; a level or stage of a game, an identification of a game; an identification of a product queried by a consumer; or a selection of products similar to a specified product. In some implementations, parameters can include consumer operated kiosk system specifics such as kiosk locations, inventory, or restocking conditions. Implementations of detecting events relevant to sample interest and obtaining associated parameters are described in more detail below in relation to blocks 520-528 of FIGS. 5A-5F.

At block 430, process 400 generates an inducement. An inducement can include any kind of message, display, or computing system output configured to promote, provoke, entice, incentivize, or otherwise facilitate a consumer interaction with a consumer operated kiosk. In various implementations, an inducement can be displayed on a mobile device at the time an event relevant to sample interest is detected, by adding an inducement to a list in a designated area of a sample app, or by scheduling the inducement to be displayed, such as upon the next launch of a sample app, web browser, or navigation program. An inducement can include, for example, an advertisement received from a third party for one or more products, a notification that a product is available at a selected consumer operated kiosk, an award of a free or discounted sample, a notification that one or more sample purchases are complete, a notification that one or more samples are reserved, a map or directions to a selected consumer operated kiosk, or an entertainment achievement which can unlock features such as promotion codes or game levels. An example of a user interface displaying an inducement 806, including a promotion code 808 is shown in FIG. 8E. In some implementations, inducements can promote interaction with a consumer operated kiosk by encouraging further use of a sample app, which in turn can result in additional inducements being provided to the consumer. Implementations of generating and providing inducements are described in more detail below in relation to blocks 530-538 of FIGS. 5A-5F.

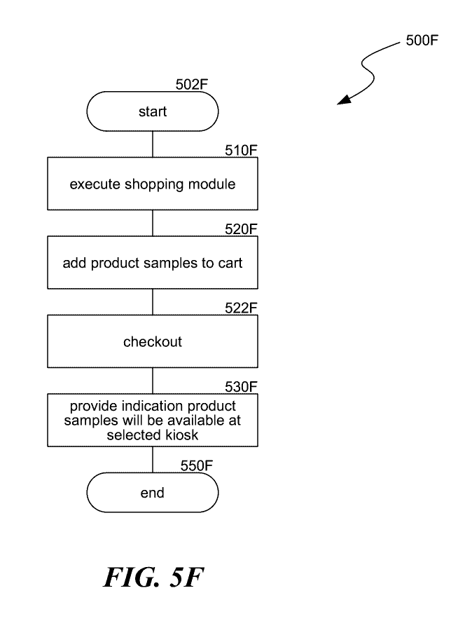

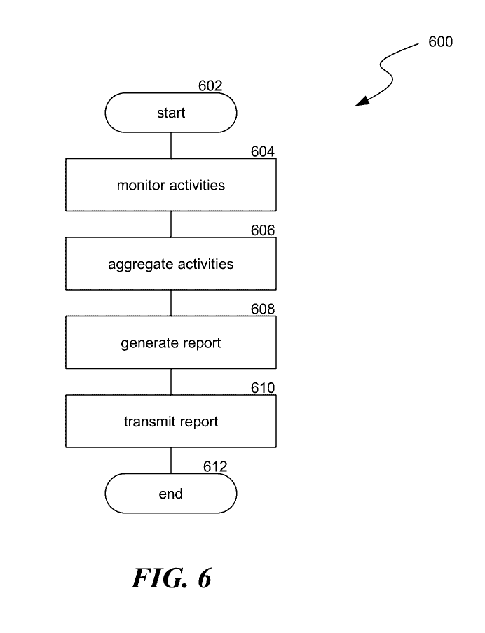

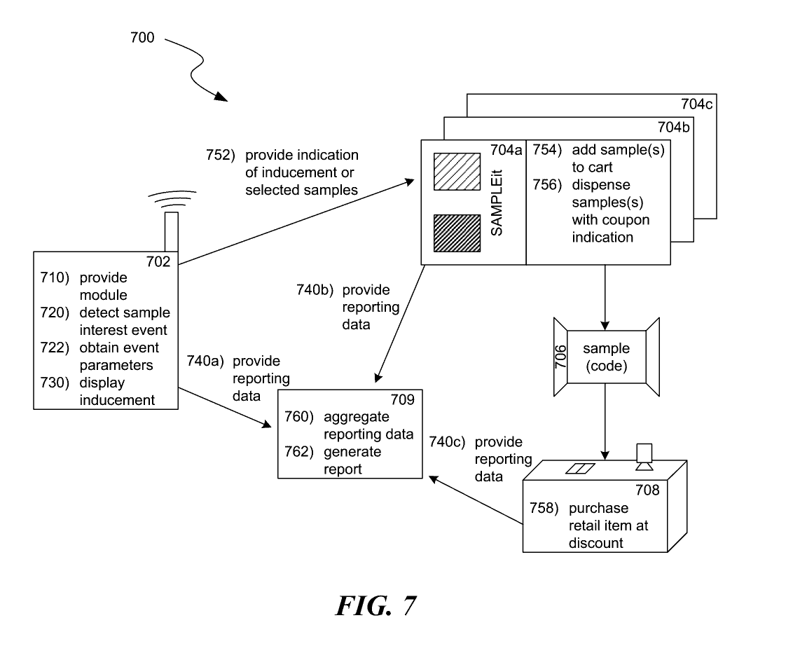

At block 440, process 400 can log inducement results at the mobile device, remote server, and/or other resources. Inducement results can include any activity performed on the mobile device, subsequent to the inducement such as when and for how long a consumer used an interaction module, levels of interaction with products in a sample app, activities that prompted use of an interactions module, activities that prompted a consumer to mark a product sample as a favorite or otherwise interact with it, activities that prompted a consumer to visit a consumer operated kiosk, etc. Implementations of logging inducement results and other related activities are described in more detail below in relation to FIG. 6 and elements 740a-c of FIG. 7.

FIG. 5A is a flow diagram illustrating an implementation 500A of the process 400 for inducing consumer operated kiosk interactions by notifying a consumer of availability of a product for which the consumer voted. Implementation 500A begins at block 502A and continues to block 510A. At block 510A, an interaction module is provided in the form of a voting interface displayed on e.g., a mobile device. In some implementations, the voting interface can allow a consumer to vote for a product sample the consumer would like to see added to a selected kiosk or to be added to a system of consumer operated kiosks.

At block 512A, a user of a mobile device enters a vote indicating a product, product type, brand, etc., that a consumer would like added to a particular kiosk inventory, or one for which the consumer would like to receive a sample. Voting can occur through numerous types of user-interface selections, such as typing the name of a product, selecting the product from a list, selecting a product rating, etc. In some implementations, a module on the mobile device can record a vote automatically. For example, an inducement module can observe that a consumer performs a query for a particular product. The module can automatically cast a vote to have that product added to a kiosk identified as a favorite of the consumer. In some embodiments, the consumer operated kiosk system can add samples of a product to a selected one or more kiosks when a threshold number of votes are received from, e.g., a plurality of consumers, for that product. The mobile device can also provide an inducement notifying the consumer of the addition of a product sample which they may be interested in to their favorite consumer operated kiosk.

Votes can be correlated with a particular consumer operated kiosk. This can occur, for example, by a consumer selecting a consumer operated kiosk from a map or by using a kiosk previously selected as a favorite. This can also occur through an automatic selection of a consumer operated kiosk, such as the consumer operated kiosk the consumer visits the most or is most often near.

At block 514A, the mobile device can transmit a message indicating the vote to a consumer operated kiosk system, e.g. using communication devices 142. Consumer operated kiosk system administrators, which can be people, software, or other entities, can receive these votes and, either based on a single vote or a number of similar votes exceeding a threshold amount, can determine that new products should be added to the consumer operated kiosk system or that one or more products available at a different consumer operated kiosk should be added or redistributed to the consumer operated kiosk indicated in the votes. Alternatively or in addition, the disclosed technology can collect data relating to votes and use it in marketing the consumer operated kiosk system to retailers, manufactures, product sample providers, etc. For example, if consumer operated kiosk administrators received many votes for a particular type of product, such as a particular makeup, to be added to the consumer operated kiosk system, this data could help persuade the makeup producer to provide samples for the consumer operated kiosk system. or to distribute more profits to the consumer operated kiosk administrators.

At block 520A, the process receives an indication of a match between a consumer's vote and an available product. In various implementations this can include an indication that the product the consumer voted to have added to a particular consumer operated kiosk has been added to that consumer operated kiosk, that the product the consumer voted to have added to a particular consumer operated kiosk is available at another kiosk the consumer may be interested in visiting, or that samples are now available for a product the consumer voted to have added to the consumer operated kiosk system. In some implementations, instead of finding an exact match for the product, product brand, or product type the consumer voted for, a match is found for a product, product brand, or product type identified as being similar to the one the consumer voted for. For example, a consumer may have voted to have a particular shampoo sample added to a local consumer operated kiosk, and a match can be provided indicating that while that exact shampoo is not available, a similar type of shampoo is available. As another example, a match can be provided indicating that, although the desired shampoo is not available, a conditioner of the same brand is available at a kiosk just two miles from the kiosk indicated in the vote.

At block 530A, the process can display an inducement for the product, brand, or product type for which the match is found. The inducement can be, for example, a notification that samples of the matched product are available in the consumer operated kiosk system or at a particular kiosk. The inducement can be a promotion code for the matched product, an advertisement for the matched product, a map or directions to a kiosk indicated in the vote or to an alternate kiosk that has a matched product, etc. The inducement can be displayed on, for example, the consumer's mobile device immediately after receiving the vote, or when a subsequent product addition or restocking event occurs. The inducement can be displayed as a mobile device notification, as an event upon executing a sample app, as a notification in another area of the sample app such as the voting interface or a messages area, or through another means of contacting the consumer such as SMS, email, etc. At block 550A, implementation 500A of process 400 ends.

FIG. 5B is a flow diagram illustrating an implementation 500B of the process 400 for inducing consumer operated kiosk interactions by providing an indication of a product determined to be of interest to a consumer. The implementation 500B of the process 400 begins at block 502B and continues to block 510B. At block 510B, the process can execute an activity monitoring interaction module. In some implementations, the activity monitoring interaction module can be configured to identify products a consumer is viewing in a sample app at one of various levels of interaction. Examples of the various levels of interaction include viewing products resulting from a product sample search, interacting with a product sample indication in an entertainment module, viewing all products in a selected category, viewing products in a selected list, viewing a details page for a project, adding product samples to a shopping cart, or purchasing product samples. In some implementations, the activity monitoring interaction module can be configured to identify consumer actions in another application such as a web browsing app; an e-commerce app; a reading app; a news app; a music, video or image app; a navigation app; a game; a communication app; social media app; etc. For example, the activity monitoring interaction module can identify a product associated with an advertisement the consumer selected in a web browser app. In some implementations, the activity monitoring interaction module can identify a product by observing incoming or outgoing communications from the mobile device, such as the content of emails or text messages.

At block 512B, the process can compare the monitored activities to activity sets that correspond to one or more products, product types, brands, or consumer operated kiosks. Activity sets can be any of the activities monitored for at block 510B that have been determined to indicate consumer interest in one or more products. For example, an activity set can include making a post in a social media app that references a product, and/or receiving a message that references the product. As another example, an activity set can include the single action of selecting a product detail page in a sample app. In some implementations, activity sets can be conditional on characteristics of the consumer, which can be tracked or logged in a user profile. A user profile can be developed for a particular consumer, identifying a particular age, gender, location, interests, friend group, heritage, or any other biographical, contextual, or cognitive characteristics. For example an activity set can be specified for users who are between ages 21 and 35, live in New York, and have played a song by a particular artist on their mobile device.

At block 520B, the process can identify one or more products based on one or more of the matches between monitored activities and activity sets identified at block 512B. In some implementations, products of interest can be pre-mapped to particular activity sets. In some implementations, products of interest can be dynamically determined based on conditions of the monitored activities, conditions of a consumer who performed the monitored activities, or settings in the consumer operated kiosk system. For example, a database can indicate that, for a particular matched activity set, one of three products can be selected as a product of interest. As another example, a match can exist between a monitored activity of identifying a mobile device location and an activity set identifying one of a number of hair salon locations, including the identified location. In this example, the process can base the product of interest on conditions of the activity such as which day of the week that the consumer was at the location or which of the hair salon locations the consumer visited. In yet another example, a product of interest can be conditional on the user profile data, described above. In this example, the process can find a match between the monitored activity of visiting websites and an activity set for a particular website of a product sample producer. If the consumer has a user profile identifying them as a male over age 20, the process can set the product of interest as a cologne sample, but if the user profile indicates the consumer as a female under age 17 the process can set the product of interest to nail polish. In some implementations, selecting products of interest can include finding a similar product, such as by type, brand, or identified product substitutions, to a product initially mapped to a match between monitored activities and activity sets. In some implementations, selecting a product of interest can be based on a determination that particular products should be featured or promoted. For example, the process can select products or give products higher priority in the selection algorithm based on their having a higher profit margin, an indication of higher interest by other consumers, being over stocked, or due to deals with product vendors to feature their products.

At block 522B, the process can gather consumer operated kiosk system data to determine a kiosk of relevance. As used herein, a kiosk of relevance can be a consumer operated kiosk with which the consumer has had past interactions, which is near the consumer's home, work, or some other location associated with the consumer, near the current location of the consumer, or that has been marked as a favorite or otherwise selected by the consumer. In some implementations, a consumer operated kiosk of relevance may be limited to one that generally stocks, or currently has in stock, the product of interest identified at block 520B. In some implementations, an inducement does not require an identification of a consumer operated kiosk of relevance, in which case block 522B can be skipped.

At block 530B, the process provides an inducement to the consumer for the product of interest or consumer operated kiosk of relevance. Some examples of inducements include advertisements for the product of interest; promotions or discounts, such as a character code or QR code for the product of interest; an indication for the product of interest to be displayed prominently in a sample app, such as in a “specials” area or on an initial screen upon loading the sample app; maps or directions for the consumer operated kiosk of relevance; or notifications that the consumer is near the consumer operated kiosk of relevance. In some cases, the inducement can indicate both the product of interest or consumer operated kiosk of relevance.

FIG. 5C is a flow diagram illustrating an implementation 500C of process 400 for inducing consumer operated kiosk interactions by providing content pushed from a third party. Implementation 500C of process 400 begins at block 502C. At block 510C, the process can execute a notification receipt interaction module. The notification receipt interaction module can be a background process of the mobile device always ready to receive a notification, can be executed upon the launch of a sample app to query a server for pending notifications, or can be triggered by other events on the mobile device, such as receiving a text or other type of message. An example of a user interface implementing inducements loaded upon the launch of a sample app is shown in FIG. 8G.

At block 520C, the notification receipt interaction module receives notification data. The notification data can be for a local, favorite, or otherwise identified consumer operated kiosk, such as one that has had a restock event, has added a new product, is a newly added consumer operated kiosk, etc. The notification data can include data for or about a particular product, product type, or brand. For example, the notification data can include an indication of a currently trending product, content to include in an advertisement for a product, an indication of a product to push, such as a product with a high profit margin or for which it has been determined remotely that the consumer is likely to have an interest, indications of promotion programs or associated codes, etc. The notification data can be for products in the consumer operated kiosk system or as a reminder for the consumer operated kiosk system, such as a message indicating that the consumer has not used the system in a threshold amount of time with a promotion code offer for the consumer to come back to try a sample.

At block 530C, the process can display an inducement that uses the information received at block 520C. As described above, the process can display inducements in various contexts and in different formats. Implementation 500C of process 400 then continues to block 550C, where it ends.

FIG. 5D is a flow diagram illustrating an implementation 500D of process 400 for inducing consumer operated kiosk interactions by monitoring location information and providing location based content. Implementation 500D of process 400 begins at block 502D. At block 510D, the process can execute a location monitoring interaction module. The location monitoring interaction module can monitor the current location of a mobile device. In various implementations, the monitoring can occur continuously or at intervals, as a background process, upon a consumer request, such as when the consumer asks for directions to a consumer operated kiosk, or as a response to another consumer action, such as when a consumer launches a sample app.

At block 512D, the process can receive location information. In various implementations, location information can be determined using global positioning system (“GPS”) data, identified local networks, a signal from a nearby consumer operated kiosk, or direction, motion or acceleration data.

At block 520D, the process can compare the location information received at block 512D to identified locations of interest. Locations of interest can include, for example, a location at or near a consumer operated kiosk, a retailer with a consumer operated kiosk, a competitor retailer, a store or manufacturer related to a product sample stocked by a consumer operated kiosk system, or an identified location related to a consumer, such as a home, work, or favorite location. In some implementations, the locations of interest can include directions or part of a route to another location of interest, such as an upcoming turn included as part of driving directions to an identified consumer operated kiosk. This comparison can occur using location of interest data downloaded to the mobile device or can be performed by sending the location information through a network connection for comparison to location of interest data by a server or other remote computing system. At block 522D, the process can identify a location of interested based on the comparison performed at block 520D.

At block 530D, the process can display an inducement related to the location of interest identified at block 522D. An inducement related to the identified location of interest can be, for example, a map or set of directions, a notification that the mobile device is within a threshold distance of a consumer operated kiosk, or an advertisement or special offer for a product sample stocked by a consumer operated kiosk local to the location of interest. Implementation 500D of process 400 then continues to block 550D, where it ends.

FIG. 5E is a flow diagram illustrating an implementation 500E of process 400 for inducing consumer operated kiosk interactions by giving achievements in response to a consumer using an entertainment module. Implementation 500E of process 400 begins at block 502E and continues to block 510E. At block 510E, the process can provide an entertainment module. An entertainment module can include, for example, a game, puzzle, or trivia application, a music player, a video player, a web interface or browser, an image viewer, a messaging system, an e-reader application, or a sample application. In various implementations, the entertainment module can be single or multi-player. In some implementations, a multi-player entertainment module can interface with friends of the consumer, which can be specified in social media accounts. In some examples, the entertainment module is a game of chance where a consumer can activate the module to gain achievements. An example of a user interface implementing this type of entertainment module as a virtual spinner wheel is shown in FIG. 8C. In some implementations, a game of chance or other entertainment module can be limited to a number of plays within a set time period, such as once per day.

At block 520E, the process can detect an achievement within the provided entertainment module. In some implementations, the achievement can include an accomplishment in a game such as a correct answer to a question, a completion of a level, an accomplishment of a goal, an amount of time played, an in-app purchase, or a positive outcome of a randomized or apparently randomized game of chance. For example, a consumer can play a game-type entertainment module and complete a purchase for a virtual item. The process can award an achievement for the purchase, giving the consumer a free sample along with their purchased virtual item. In some implementations, the achievement can be the completion of a specified action or set of actions within a sample app, such as opening the sample app for the first time, consecutive uses over a period of time, an amount of time used, access to particular portions of the sample app, or performing a level of interaction with a specified portion of the sample app, such as completing a sample purchase. An example of a user interface showing an achievement 822 for using an entertainment module for the first time is shown in FIG. 8D. In some implementations, the process can base the achievement on viewing or opening particular content items, such as viewing a specified image or clicking on a specified advertisement. In some implementations, the process can base the achievement on a user performing content sharing, such as monitored portions of messages or social media interactions including “liking” a product sample or the sample app, posting or providing a message to a friend about a product sample, consumer operated kiosk, the sample app, or other entertainment module.

At block 522E, the process can correlate the achievement detected at block 520E to a product of interest. In some implementations, the correlated product of interest can be based on the event that caused the achievement. For example, the consumer can have been prompted to select a product sample they would like to play for prior to activating a game of chance or the consumer could have been motivated to make an in-app purchase based on the purchase including a free or discounted sample of a specified product. In some implementations, the product of interest can be for a category of products or can be left generic. For example, a consumer may receive an achievement that entitles them to one free sample of their choosing, in which case the product of interest can be left generic as any product sample available in a consumer operated kiosk system. In some implementations, the process can base the product of interest on other factors identified for the consumer such as was described above in relation to implementation 500B. In some implementations, the product of interest can be based on other information provided to the mobile device such as was described above in relation to implementation 500C.

At block 530E, the process can obtain a promotion code for a product of interest. In some implementations where the product of interest is left generic, the promotion code can be for a type, brand, or a specified number of any product. In various implementations, the process can obtain the promotion code by dynamically generating it upon completion of the achievement or the process can select it from a set of previously generated promotion codes mapped for selection upon consumer achievements. In various implementations, codes can be specified as a string of characters, a bar code, a QR code, another image, an audio tone, etc. In various implementations, inducements can use features other than promotion codes, in which case these other features can be obtained at block 530E. For example, the features can include unlocking a further level or area of the entertainment module, a product advertisement, or information about the consumer operated kiosk system including locations, directions, or product availability. In some implementations, achievements can result in free or discount product samples that a consumer can access by means other than a promotion code, such as by associating with a user profile or payment method an indication that the consumer is entitled to the free or discounted product. For example, instead of generating a promotion code, at block 530E, the process can store an association between the consumer's credit card and one free product. When the consumer interacts with a consumer operated kiosk using that credit card, the process can provide them with the free sample instead of charging the credit card.

At block 532E, the process can display an inducement indicating the promotion code or other features obtained at block 530E. For example the inducement can include an in-game event indicating that the achievement has been achieved; a list of achievements can be updated for later consumer viewing; additional entertainment module features can be unlocked; a message can be sent to the consumer such as via text or email; a flag can be set to notify the consumer of achievements, promotion codes, or other features upon the next launch of the sample app; etc. Implementation 500E of process 400 then continues to block 550E, where it ends.

FIG. 5F is a flow diagram illustrating an implementation 500F of process 400 for inducing consumer operated kiosk interactions through e-commerce purchases. Implementation 500F of process 400 begins at block 500F and continues to block 510F. At block 510F, the process can execute a shopping module. The shopping module can include a user interface allowing consumers to browse product samples and select product samples to purchase.

At block 520F, a consumer can add one or more product samples to a “cart” for purchase using the shopping module. At block 522F, the process can complete a purchase transaction for products in the cart through a checkout procedure. In some implementations, the process can associate adding product samples to a cart or the subsequent checkout process with a particular consumer operated kiosk. In various implementations, adding product samples to a cart or the subsequent checkout process can limit available items to add to the cart or to purchase based on the current stock in the particular consumer operated kiosk or can include a notification of availability at the selected consumer operated kiosk. In some implementations, when the selected product sample is not available at the particular consumer operated kiosk, the process can suggest an alternate consumer operated kiosk. For example, a consumer can use the shopping module to select a consumer operated kiosk near them and browse product samples. The shopping module can show only product samples in stock in the selected consumer operated kiosk, indicate some product samples cannot be selected such as by greying them out, or indicate that product samples are not available in the selected consumer operated kiosk. When a consumer selects a product sample that is not available in the selected consumer operated kiosk, the shopping module can provide a notification of an alternate consumer operated kiosk, such as: “The sample you selected is not available in the current kiosk, however it is available at two other kiosks within one mile. Would you like to select an alternate kiosk for pickup of your product samples?” In some implementations, the checkout process can be a reservation of the selected product samples, which the consumer can pay for when they pick them up at a consumer operated kiosk.

At block 530F, an indication of the completed purchase is provided to the consumer. In various implementations, this indication can include a receipt, a map to the selected consumer operated kiosk, a pickup time window, advertisements, or additional promotions for discounts based on their purchase. Implementation 500F of process 400 then continues to block 550F, where it ends.

FIG. 6 is a flow diagram illustrating a process 600 used in some implementations for generating a usage report related to usage of a product sample system. Process 600 begins at block 602 and continues to block 604. At block 604, the process 600 can monitor activities related to a product sample system. In various implementations, the monitored activities can be on a mobile device, on a consumer operated kiosk, or using a point-of-sale system. In some implementations, monitored activities on a mobile device can include any of the procedures described above in relation to FIGS. 3, 4, and 5A-F. In some implementations, monitored activities on a consumer operated kiosk can include products viewed, selected, or purchased, advertisements viewed, or promotions used. In some implementations, monitored activities using a point-of-sale system can include purchases resulting from a disbursement of a product sample, such as the use of coupons included with a dispensed product sample. Data included with monitored activities can include a location, time, consumer operated kiosk identification, retail location identification, product identification, or product category. Data included with monitored activities can also comprise a level of interaction with a product sample, such as showing up in a list, viewing product details, purchasing a product sample, or purchasing a retail versions of a product. Data included with monitored activities can also comprise consumer information such as a current location, other locations associated with the consumer, the consumer age, gender, purchase history, other identified products of interest for the consumer, etc.

At block 606, the process 600 can aggregate the activities monitored at block 604. Activity aggregation can take a set of individual activities and group them according to common parameters. In various implementations, activity aggregation can be based on pre-defined report requirements or a query searching for specified common activity parameters. In some implementations, the process 600 can perform activity aggregation by analyzing groups of activities for commonalities, without pre-specifying a type of commonality for which to search. The process 600 can aggregate monitored activities at the mobile device, consumer operated kiosk, or another centralized activity logging station.

At block 608, the process 600 can generate a report using aggregated activities. The generated report can be for activities performed generally across all consumers, for a particular consumer group, for an individual consumer, by consumer operated kiosk location, retail location, timeframe, product, product type, brand, etc. At block 610, the process 600 can transmit the report generated at block 608 to an interested entity. Examples of these entities can include a consumer operated kiosk system administrator, product sample provider or potential provider, retail location owner or administrator, or other entity interested in product sample performance. Process 600 continues to block 612, where it ends.

FIG. 7 is process flow 700 illustrating example interactions between various entities implementing the disclosed technology. The depicted entities include a mobile device 702 (e.g., a smart phone), an example of which is the mobile device 102, consumer operated kiosks 704, an example of which is the consumer operated kiosk 109, a product sample 706, a point-of-sale station 708 (e.g., a cashier aisle at a retail outlet), and a data activity aggregation system 709. The depicted processes begin in the mobile device 702 with steps 710-730. At 710, an interaction module can be provided, as described above in relation to element 344 of FIG. 3, element 410 of FIG. 4, and elements 510-519 of FIGS. 5A-5F. At 720, interest events can be detected, and at 722, parameters for the events can be obtained, as described above in relation to element 410 of FIG. 4 and elements 520-529 of FIGS. 5A-5F. At 730, an inducement can be generated and displayed, as described above in relation to element 346 of FIG. 3, element 430 of FIG. 4, and elements 530-539 of FIGS. 5A-5F.

At 752, an indication of an inducement or selected product samples can be provided from the mobile device 702 to a consumer operated kiosk 704a. This can be though a promotion code provided to a consumer and entered by the consumer at the kiosk, or through a transmission sent from the mobile device 702 to the kiosk 704a (e.g. via a near field communication, WiFi, Bluetooth, or other wired or wireless connection between the mobile device 702 and the kiosk 704a), or a transmission sent from a server in communication with both the mobile device and the kiosk 704a. For example, the inducement can include an image of a bar or QR code which can be presented to user interface, such as touch screen, an imaging system, etc. at a consumer operated kiosk system to indicate the promotion that should be used for the current transaction.

The depicted processes continue in the consumer operated kiosk 704a with steps 754-756. At 754, samples can be added to a cart. This can be based on the indication provided at 752 or by a consumer product sample selection at the consumer operated kiosk 704a. At 756, the consumer operated kiosk 704a dispenses a product sample 706. Dispensing product sample 706 can be in response to the consumer checking out product samples added to the cart by making a payment or using a free product dispensement assigned to the consumer. The dispensed product sample 706 can include a coupon indication or code. The coupon indication or code can include an offer to reduce the cost of a retail version of the product sample 706. In some implementations, the amount of the reduction can be equal to all or a specified percentage of the amount the consumer paid for the product sample.

The consumer operated kiosk 704a can comprise a control module, a user input interface, product sample inventory, a product sample display, and a product sample dispensing unit. The input interface can be coupled to the control module, and can be configured to receive, through interaction with a mobile device (e.g. wired, wireless, image capture, etc.), the indication of one or more vend or dispense inducements provided on the mobile device. The product sample dispensing unit can be coupled to the control module, can be configured to receive a dispense signal from the control module, and can dispense one or more product samples in response to the dispense signal. The control module can be configured to generate the dispense signal by: identifying one or more products indicated by a consumer or indicated in the vend or dispense inducements; correlating the vend or dispense inducements to a product discount indicated to the consumer on the mobile device; performing a product checkout procedure for the identified one or more products using the product discount; and generating the dispense signal in response to successful completion of the checkout procedure.

The depicted processes continue in the point-of-sale station 708 with step 758. At 758, a retail version of the product sample 706 can be purchased. In implementations, where the sample includes a coupon indication or code to reduce the cost of the retail version of the product the purchase can be discounted using the coupon or code included with the product sample 706. For example, the coupon can include a barcode that is swiped at a point-of-sale station to discount the cost of the retail version of the product. As another example, the code can be included with a proof of purchase of the retail version for a rebate.

As the processes described above continue, data can be provided to data activity aggregation system 709 with steps 740a-c. The data activity aggregation system 709 can aggregate the reporting data at 760 and generate a report at 762, as described above in relation to elements 348-352 of FIG. 3, element 440 of FIG. 4, and FIG. 6.

Several implementations of the disclosed technology are described above in reference to the figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to a union of all possible permutations of a set of items (i.e. “and/or”). For example, the phrase “A, B, or C” refers to any of A; B; C; A and B; A and C; B and C; or A, B, and C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above, are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method of inducing consumer interaction with one or more consumer operated kiosks, the method comprising:
executing, on a mobile device, one or more interaction modules, the one or more interaction modules configured to monitor for events related to consumer interest in one or more product samples;
detecting, by at least one of the one or more interaction modules, a detected one of the events related to the consumer interest in the one or more product samples;
obtaining parameters of the detected one of the events; and
generating, based on the obtained parameters, one or more of the inducements configured to be used at one or more consumer operated kiosks, the use resulting in dispensing one or more product samples from one or more kiosks.

2. The method of claim 1 wherein the consumer interaction with the one or more consumer operated kiosks comprises a vend or dispense action by the one or more consumer operated kiosks.

3. The method of claim 1 wherein:
executing the one or more interaction modules comprises providing an interface configured to receive a vote for a product;
detecting the events related to the consumer interest comprises receiving an indication of a match between (a) the vote for the product received through the interface and (b) a product sample available at a consumer operated kiosk; and
the generated one or more vend or dispense inducements comprise one or more of:
a promotion code for the product sample available in the consumer operated kiosk; and/or
a map or directions to the consumer operated kiosk.

4. The method of claim 1 wherein executing the one or more interaction modules comprises providing an interface configured to receive a vote for a product to add to a consumer operated kiosk.

5. The method of claim 1 wherein executing the one or more interaction modules comprises providing an interface configured to receive a vote for a product.

6. The method of claim 1 wherein:
at least one of the one or more interaction modules is configured to monitor levels of consumer interactions with product sample representations, wherein each of the product sample representations represent a product sample available at a consumer operated kiosk;
detecting the events related to the consumer interest comprises:
matching (a) a monitored level of interaction of a consumer interaction with one or more product sample representations with (b) an activity set indicating a corresponding level of interaction; and
identifying one or more products of interest from the product samples available at the consumer operated kiosk, wherein the identifying is based on the consumer interaction with one or more product sample representations that represent the one or more interest products; and
the generated one or more inducements comprise one or more of:
a promotion or discount for the one or more products of interest; and/or
an instruction provided to a sample app configured to cause the sample app to prominently display the one or more products of interest.

7. The method of claim 1 wherein:
at least one of the one or more interaction modules is configured to monitor levels of consumer interactions with product sample representations, wherein each of the product sample representations represent a product sample available at a consumer operated kiosk.

8. The method of claim 1 further comprising determining one or more kiosks of relevance by selecting a consumer operated kiosk:
with which a consumer has had past interactions, and/or
which has been marked as a favorite by the consumer.

9. The method of claim 1 further comprising determining one or more kiosks of relevance by selecting a consumer operated kiosk:
which is near a previous location associated with the consumer, or
which is near a current location of the consumer.

10. The method of claim 1 wherein:
the one or more interaction modules comprises a location monitoring module configured to identify a current location of the mobile device;
detecting the events related to the consumer interest comprises matching the identified current location to one or more locations of interest, wherein the locations of interest include one or more of:
a location at or near a consumer operated kiosk;
a location of a retailer with the consumer operated kiosk, and/or
a location identified by the consumer as a favorite location; and
the generated one or more vend or dispense inducements comprises one or more of:
a map or set of directions, and/or
a notification that the mobile device is within a threshold distance of a particular consumer operated kiosk.

11. The method of claim 1 wherein:
the one or more interaction modules comprises a location monitoring module configured to identify a current location of the mobile device;
detecting the events related to the consumer interest comprises matching the identified current location to one or more locations of interest, wherein the locations of interest include one or more of:
a location at or near a consumer operated kiosk;
a location of a retailer with the consumer operated kiosk, and/or
a location identified by the consumer as a favorite location; and
the generated one or more vend or dispense inducements comprises an advertisement and/or a special offer for a product sample stocked by a consumer operated kiosk local to the location of interest.

12. The method of claim 1 wherein:
the one or more interaction modules comprises a location monitoring module configured to identify a current location of the mobile device; and
detecting the events related to the consumer interest comprises matching the identified current location to one or more locations of interest, wherein the locations of interest include one or more of:
a location at or near a consumer operated kiosk; and/or
a location of a retailer with the consumer operated kiosk.

13. The method of claim 1 wherein:
the one or more interaction modules comprises a location monitoring module configured to identify a current location of the mobile device; and
detecting the events related to the consumer interest comprises matching the identified current location to one or more locations of interest, wherein the locations of interest include a location identified by the consumer as a favorite location.

14. The method of claim 1 wherein:
executing the one or more interaction modules comprises an entertainment module configured to present one or more of: a game of chance, a puzzle, and/or a trivia application; and
detecting the events related to the consumer interest comprises detecting an achievement including one or more of:
a correct answer to a question;
an amount of time played; and/or
a positive outcome of the game of chance.

15. The method of claim 1 wherein:
the one or more interaction modules comprises an entertainment module configured to present one or more of: a game of chance, a puzzle, and/or a trivia application.

16. The method of claim 1 wherein:
executing the one or more interaction modules comprises an entertainment module configured to present a game of chance;
detecting the events related to the consumer interest comprises detecting a positive outcome of the game of chance; and
the generated one or more vend or dispense inducements comprises a promotion code for a product of interest corresponding to the positive outcome of the game of chance.

17. The method of claim 1 wherein:
executing the one or more interaction modules comprises executing a sample app; and
detecting the events related to the consumer interest comprises detecting one or more of:
opening the sample app for the first time;
consecutive uses over a period of time;
an amount of time used; and/or
access to one or more particular portions of the sample app.

18. The method of claim 1 further comprising transmitting a log of inducement results to a data activity aggregation system.

19. The method of claim 1 further comprising transmitting a log of inducement results to a data activity aggregation system, wherein the inducement results comprise one or more of:
product or product category viewed;
product or product category selected;
product or product category purchased;
advertisements viewed;
promotions used; and/or
a consumer operated kiosk identification.

20. A consumer operated kiosk system for vending or dispensing product samples comprising:
product sample inventory;
a memory;
one or more processors;
a control module;
an input interface, coupled to the control module, configured to receive through interaction with a mobile device, an indication of one or more inducements provided on the mobile device; and
a product sample dispensing unit, coupled to the control module, configured to receive a dispense signal from the control module and dispense one or more product samples indicated by the dispense signal;
wherein the control module is configured to generate the dispense signal by:
identifying one or more products indicated by a consumer or indicated in the inducements.

21. The consumer operated kiosk system of claim 20 wherein the control module is further configured to generate the dispense signal by:
correlating the inducements to a product discount indicated to the consumer on the mobile device;
performing a product checkout procedure for the identified one or more products using the product discount; and
generating the dispense signal in response to successful completion of the checkout procedure.

22. The consumer operated kiosk system of claim 20 wherein product sample inventory comprises one or more product samples of products corresponding to retail versions of the products.

23. The consumer operated kiosk system of claim 20 wherein:
the control module is further configured to generate the dispense signal by:
correlating the inducements to a product discount indicated to the consumer on the mobile device;
performing a product checkout procedure for the identified one or more products using the product discount; and
generating the dispense signal in response to successful completion of the checkout procedure;
the indication of one or more inducements is a string of characters entered by a consumer indicating a promotion code for a particular product sample;
the product discount is for one free item of the particular product sample; and
performing the product checkout procedure includes providing the dispense signal for the particular product sample without charging for the particular product sample.

24. The consumer operated kiosk system of claim 20 wherein the indication of one or more inducements is a string of characters entered by a consumer indicating a promotion code.

25. A computer-readable medium storing instructions that, when executed by a computing system, cause the computing system to perform operations for reporting on activities related to sample dispensing of one or more consumer operated kiosks, the operations comprising:
receiving an indication of multiple activities, wherein at least one of the multiple activities is related to a conversion of (a) a vend or dispense interaction from at least one of the one or more consumer operated kiosks into (b) a retail purchase;
aggregating a plurality of the multiple activities into one or more aggregate groups based on aggregation parameters relevant to an entity associated with the vend or dispense interaction and/or retail purchase;
generating a report based on the one or more aggregate groups; and
transmitting the report to the entity.

26. The computer-readable medium of claim 25 wherein at least some of the indications of monitored activities include one or more of:
a time of monitored activities; and/or
a product identification.

27. The computer-readable medium of claim 25 wherein at least some of the indications of monitored activities include one or more of:
a consumer operated kiosk identification; and/or
a retail location identification.

28. The computer-readable medium of claim 25 wherein at least some of the indications of monitored activities include a level of a consumer interaction with an indication of a product sample in a sample app.
